(19) United States
(12) Patent Application Publication
(10) Pub. No.: US 2019/0071029 A1
(43) Pub. Date: Mar. 7, 2019

(54) SVM SYSTEM HAVING FUNCTION TO PROVIDE BVM IMAGE AND OPERATING METHOD THEREOF

(71) Applicants: Hyundai Motor Company, Seoul (KR); Kia Motors Corporation, Seoul (KR)

(72) Inventors: Jae Seob Choi, Suwon (KR); Kap Je Sung, Suwon (KR); Jun Hyung Kim, Suwon (KR); Joong Ryoul Lee, Incheon (KR); Jun Sik An, Anyang (KR)

(21) Appl. No.: 16/117,751

(22) Filed: Aug. 30, 2018

(30) Foreign Application Priority Data
Sep. 5, 2017 (KR) 10-2017-0113314

(51) Int. Cl. B60R 11/04; B60R 1/00; H04N 9/73; B60W 50/14

(52) U.S. Cl. CPC B60R 11/04; B60R 1/00; B60R 2001/1253; B60W 50/14; H04N 9/735

(57) ABSTRACT

A SVM system capable of providing a BVM image is provided. The system operates a SVM mode or a BVM mode depending on the driving state of a vehicle, and thus provides an image optimized for each mode.

### CROSS-REFERENCE TO RELATED APPLICATION

This application is based on and claims the benefit of priority to Korean Patent Application No. 10-2017-0113314, filed on Sep. 5, 2017, the disclosure of which is incorporated herein in its entirety by reference.

### TECHNICAL FIELD

The present disclosure relates to a surround view monitoring (SVM) system that provides a blind-spot view monitoring (BVM) image and an operating method thereof, and more particularly, to an SVM system that provides an SVM mode or a BVM mode based on the driving state of a vehicle and an operating method thereof.

### BACKGROUND

In recent years, advanced driver assistance systems (ADAS) have been installed in vehicles to increase driving safety. The ADAS may include a lane departure warning system (LDWS), a forward collision warning system (FCWS), a driver drowsiness detection system, a pedestrian detection system (PD), a traffic sign recognition system (TSR), a BVM system, and the like.

Herein, the BVM system may be an auxiliary system that allows a driver to recognize whether an object is present in a blind spot that is not visible through the side mirror when the driver changes lanes, and may generally detect a blind spot through a specially designed BVM camera or through an object recognition sensor.

A conventional technology for monitoring the blind spot of the vehicle using the SVM system may not generate an optimal BVM image since the conventional technology generates a BVM image from the image captured using an SVM camera that operates (e.g., applying an Auto Exposure (AE) tuning value optimized for SVM shooting) in a SVM mode when generating a BVM image based on the image captured through a SVM camera and then displays the generated BVM image.

In other words, the SVM camera is optimized for the brightness of the SVM mode since the SVM camera is tuned to measure the whole area of the image. However, in the BVM mode in which a blind spot image of the vehicle is provided, a saturation phenomenon may occur in the image due to the headlight of the rear vehicle. As a result, the conventional technology may be unable to prevent the saturation phenomenon (e.g., a phenomenon in which a pixel is displayed at the maximum brightness such that an object is unable to be recognized) in the image caused by the head lamp of the rear vehicle in the nighttime or in the tunnel, and thus may not provide the optimal BVM image. Additionally, installing a separate camera or other imaging device for BVM would unnecessarily increase overall costs.

### SUMMARY

The present disclosure has been made to solve the above-mentioned problems occurring in the prior art while advantages achieved by the prior art are maintained intact. An aspect of the present disclosure provides an SVM system capable of providing an image optimized for each mode by operating in an SVM mode or a BVM mode based on the driving state of a vehicle, and an operating method thereof.

Objects of the present disclosure are not limited to the above-mentioned object, and other objects and advantages of the present disclosure that is not mentioned will be understood from the following description, and it will be apparently understood from an exemplary embodiment of the present disclosure. In addition, it will be easily understood that the objects and advantages of the disclosure are realized by means and combinations described in the appended claims.

According to an exemplary embodiment of the present invention, an surround view monitoring (SVM) system having a function of providing a blind-spot view monitoring (BVM) image may include a signal input device configured to receive an SVM operation signal or a BVM operation signal, an image capture device including a front view camera, a rear view camera, a left view camera, and a right view camera, a view converter configured to generate an SVM image or a BVM image, using an image captured by the image capture device, a first display configured to display the SVM image, a second display configured to display the BVM image, and a controller. The controller may be configured to operate the left view camera or the right view camera in a BVM mode during the BVM mode, operate the view converter to generate the BVM image based on an image captured using the left view camera or the right view camera, and operate the second display to display the BVM image generated by the view converter.

According to an exemplary embodiment, the left view camera and the right view camera may operate in an SVM mode or the BVM mode under control of the controller. In addition, the BVM mode may refer to a mode in which exposure time for each area of a window is adjusted to prevent a saturation area in an image captured by the left view camera and the right view camera from being generated. Additionally, the signal input device may include an SVM button configured to generate an SVM mode signal and a turn signal input device configured to generate a left turn signal and a right turn signal, as the BVM operation signal.

Further, the controller may be configured to operate the left view camera in the BVM mode when the left turn signal is input, and operate the view converter to generate the BVM image based on the image captured using the left view camera. At this time, the view converter may be configured to output an icon that indicates that the BVM image is a left-side blind spot image of a vehicle, and the BVM image. The controller may be configured to operate the right view camera in the BVM mode when the right turn signal is input, and operate the view converter to generate the BVM image based on the image captured using the right view camera. At this time, the view converter may be configured to output an icon that indicates that the BVM image is a right-side blind spot image of a vehicle, and the BVM image.

According to an exemplary embodiment of the present invention, a BVM image providing method of an SVM system may include receiving, by a signal input device, a BVM operation signal, operating, by a controller, a camera in a BVM mode, generating, by a view converter, a BVM image by using an image captured by the camera, and displaying, by a display, the generated BVM image. The camera may operate in an SVM mode or the BVM mode under control of the controller. In addition, the BVM mode may be a mode in which exposure time for each area of a window is adjusted to prevent a saturation area in an image captured by the camera from being generated.

The BVM operation signal may include a left turn signal or a right turn signal of a vehicle. Additionally, the operating of the camera in the BVM mode may include operating a left view camera in the BVM mode when the left turn signal is input. The generating of the BVM image may include generating the BVM image based on an image captured using the left view camera and generating an icon that indicates that the generated BVM image is a left-side blind spot image of the vehicle, and the BVM image.

Further, the operating of the camera in the BVM mode may include operating a right view camera in the BVM mode when the right turn signal is input. The generating of the BVM image may include generating the BVM image based on an image captured using the right view camera and generating an icon that indicates that the generated BVM image is a right-side blind spot image of the vehicle, and the BVM image.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an SVM system having a function to provide a BVM image, according to an exemplary embodiment of the present disclosure;

FIG. 2 is a block diagram illustrating a signal input device, according to an exemplary embodiment of the present disclosure;

FIG. 3 is a block diagram illustrating a view converter, according to an exemplary embodiment of the present disclosure;

FIGS. 4A-4D are exemplar views illustrating a process to generate a BVM image, according to an exemplary embodiment of the present disclosure;

FIG. 5 is an exemplary view illustrating a display state of a BVM image, according to an exemplary embodiment of the present disclosure;

FIGS. 6A-6D are exemplary views illustrating a process to tune a camera for operating in a BVM mode, according to an exemplary embodiment of the present disclosure; and

FIG. 7 is a flowchart illustrating a method of providing a BVM image in an SVM system, according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, exemplary embodiments of the present disclosure will be described in detail with reference to the accompanying drawings. In the drawings, the same reference numerals will be used throughout to designate the same or equivalent elements. In addition, a detailed description of well-known features or functions will be ruled out in order not to unnecessarily obscure the gist of the present disclosure.

In describing elements of exemplary embodiments of the present disclosure, the terms 1st, 2nd, first, second, A, B, a, b, and the like may be used herein. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which this invention belongs. It will be understood that terms used herein should be interpreted as having a meaning that is consistent with their meaning in the context of the present disclosure and the relevant art and will not be interpreted in an idealized or overly formal sense unless expressly so defined herein.

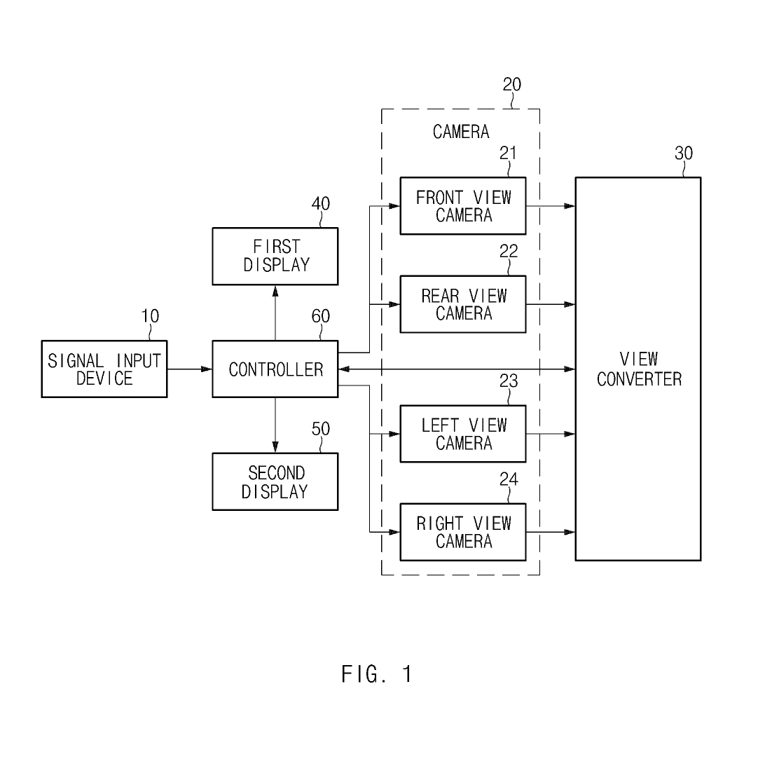

FIG. 1 is a block diagram illustrating an SVM system capable of providing a BVM image, according to an exemplary embodiment. As illustrated in FIG. 1, according to an exemplary embodiment of the present disclosure, an SVM system capable of providing a BVM image may include a signal input device 10, a camera 20 (or other type of imaging device), a view converter 30, a first display 40, a second display 50, and a controller 60. The controller 60 may be configured to operate the other components of the system. According to a method of operating the present disclosure, each of the components may be provided as one device after being combined with one another; and a part of components may be omitted depending on the method of operating the present disclosure.

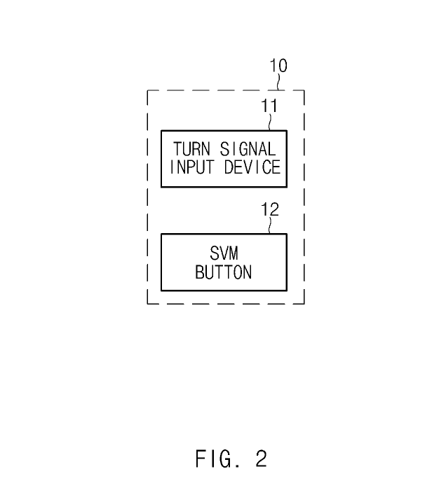

Referring to each of the components, first, the signal input device 10 may be a module configured to receive a signal as a reference for determining whether to operate in a BVM mode (BVM image quality optimization mode) or an SVM mode (SVM image quality optimization mode). The signal input device 10 may operate in the BVM mode when a first signal is input; the signal input device 10 may operate in the SVM mode, when a second signal is input. For example, as illustrated in FIG. 2, the signal input device 10 may include a turn signal input device 11 and a SVM button 12.

The turn signal input device 11 may be implemented with the multi-function switch of a vehicle, and the multi-function switch may be configured to generate a BVM activation signal in response to the manipulation of a driver. At this time, a BVM activation signal may include a left turn signal of the vehicle and a right turn signal of the vehicle. Further, the SVM button 12 may be a module configured to receive a signal indicating an operation in the SVM mode; when a button is pressed or otherwise engaged by the driver, the SVM button 12 may be configured to generate an activation signal of the SVM mode. In addition, the signal input device 10 may further include a reverse detector (or sensor not illustrated) of the vehicle and then may automatically generate the activation signal of the SVM mode when the gear of the vehicle is in the reverse gear. In other words, the reverse detector may be configured to detect a reverse gear stage and transmit the information to the controller to thus generate the activation signal of the SVM mode. The signal input device 10 may be configured to receive a BVM activation signal through a user switch and receive the BVM activation signal in conjunction with various types of systems (e.g., blind-spot collision warning (BCW), highway driving assist (HDA), or the like) in the vehicle.

The camera 20 may include a front view camera 21, a rear view camera 22, a left view camera 23, and a right view camera 24 as an image capturing device configured to capture an image at a periphery of the vehicle. The cameras 21 to 24 may be tuned to capture an optimal SVM image as essential components included in the SVM system. In particular, since the left view camera 23 and the right view camera 24 are used to provide the BVM image in the present disclosure, the left view camera 23 and the right view camera 24 may be configured to operate in a first mode or a second mode under control of the controller 60. The first mode refers to a mode optimized to capture an SVM image, and the second mode refers to a mode optimized to capture a BVM image.

The front view camera 21 may be positioned at a front of the vehicle and may be used to obtain a front view image of the vehicle. In particular, the front view camera 21 may be positioned at a central portion between both head lamps of the vehicle, but is not limited thereto. The rear view camera 22 may be positioned at the rear of the vehicle and may be used to obtain the rear view image of the vehicle. In particular, the rear view camera 22 may be positioned at a central portion between both rear lamps of the vehicle, but is not limited thereto. The left view camera 23 may be positioned on the left-side surface of the vehicle and may be used to obtain the left view image of the vehicle. In particular, the left view camera 23 may be positioned under the left side mirror of the vehicle, but is not limited thereto. The right view camera 24 may be positioned on the right-side surface of the vehicle and may be used to obtain the right view image of the vehicle. In particular, the right view camera 24 may be positioned under the right side mirror of the vehicle, but is not limited thereto.

Further, the view converter 30 may be configured to operate in the BVM mode or the SVM mode under control of the controller 60. The view converter 30 may be configured to generate the BVM image using the image captured by the camera 20, when the view converter 30 operates in the BVM mode. In other words, the view converter 30 may be configured to generate the BVM image using the image captured by the left view camera 23 of the vehicle or generate the BVM image using the image captured by the right view camera 24 of the vehicle. The BVM image may include a part of the body as an image with a wider angle of view than the side mirror. The view converter 30 may be configured to generate the SVM image using the image captured by the cameras 21 to 24, when the view converter 30 operates in the SVM mode.

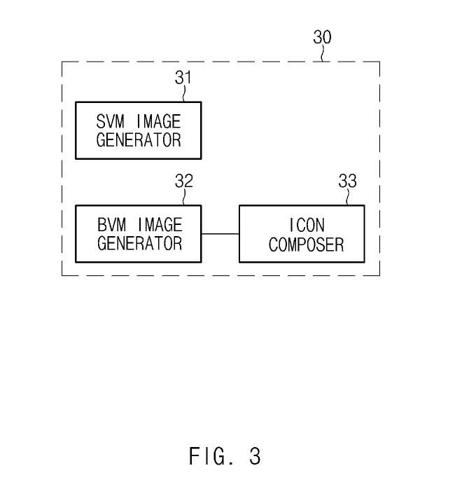

Hereinafter, the detailed configuration of the view converter 30 will be described with reference to FIG. 3. As illustrated in FIG. 3, the view converter 30 may include an SVM image generator 31, a BVM image generator 32, and an icon composer 33.

The SVM image generator 31 may be configured to generate the SVM image by using images respectively captured by the front view camera 21, the rear view camera 22, the left view camera 23, and the right view camera 24. The SVM image generator 31 may include a memory, an image converter, a detector, an image composer, and an image corrector. The front view image, the rear view image, the left view image, and the right view image of the vehicle respectively captured by the front view camera 21, the rear view camera 22, the left view camera 23, and the right view camera 24 may be transmitted to the image converter to generate an SVM image.

The memory may be configured to store various setting values for operating an SVM system and store state information regarding each operation, the result of each operation, or the like. For example, the memory may be configured to store the SVM image of the vehicle and an SVM image of the surrounding vehicle and store the image obtained by composing the SVM image of the vehicle and the SVM image of the surrounding vehicle. Additionally, the memory may be configured to store an image composition algorithm for composing SVM images. The memory may include at least one type of a storage medium among a flash memory type, hard disk type, a Solid State Disk (SSD) type, a Silicon Disk Drive (SDD) type, a multimedia card micro type, a memory of a card type (e.g., SD memory, XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc.

Furthermore, the image converter may be configured to generate the SVM image of the vehicle from the image of the periphery of the vehicle captured by the camera 20. The image converter may then be configured to convert the image, which is captured at a periphery of the vehicle, to a top view image to generate the SVM image. The image converter may also be configured to convert the SVM image of the surrounding vehicle received from the outside. The image converter may be configured to determine the relative location between the vehicle and the surrounding vehicle, based on the locations of the vehicle and the surrounding vehicle and then may be configured to convert the SVM image of the surrounding vehicle based on the location of the vehicle. For example, the image converter may be configured to compare the location and direction of the vehicle with the location and direction of the surrounding vehicle to move the SVM image of the surrounding vehicle based on the location of the vehicle and may be configured to rotate the SVM image of the surrounding vehicle based on the direction the vehicle. The image converter may not rotate the SVM image of the surrounding vehicle when the direction of the surrounding vehicle is the same as the direction of the vehicle.

The detector may be configured to compare the SVM image of the vehicle with the SVM image of the surrounding vehicle to detect an overlapping area between the SVM image of the vehicle and the SVM image of the surrounding vehicle. The image composer may then be configured to compose the SVM image of the vehicle and the SVM image of the surrounding vehicle, based on the overlapping area detected by the detector. The image composer may be configured to assign a weight based on at least one of a linear component, a distance value, and a pixel value of each of the SVM image of the vehicle and the SVM image of the surrounding vehicle and perform the weighted sum of the assigned weights on an area in which the SVM images overlap with each other to generate the SVM image of the vehicle and the SVM image of the surrounding vehicle based on the weighted sum.

In particular, the image composer may be configured to generate the SVM image of the surrounding vehicle on the SVM image of the vehicle, when generating the SVM image of the vehicle and the SVM image of the surrounding vehicle. The visible range of the composed SVM image is the same as the visible range of the SVM image of the vehicle. The image composer may be configured to generate the generated SVM image to include all of the area of the SVM image of the vehicle and the area of the SVM image of the surrounding vehicle.

Further, the image composer may be configured to generate each SVM image based on trajectory information of the corresponding vehicle, when generating the continuous SVM image, and generate an SVM image based on the feature point of each SVM image in addition to the overlapping area. The image corrector may then be configured to correct the boundary area and the empty area of the SVM image generated by the image composer. For example, the image corrector may blend the boundary area to minimize image distortion when each SVM image is generated, and interpolate an area in which the size of the weighted sum is small, or in which there is no information, with reference to information regarding the periphery of the corresponding vehicle or process the area as an empty space.

Under control of the controller 60, the BVM image generator 32 may be configured to generate the BVM image using the image captured by the left view camera 23 of the vehicle or generate the BVM image using the image captured by the right view camera 24 of the vehicle. Under control of the controller 60, the icon composer 33 may be configured to generate or compose the BVM image, which is generated by the BVM image generator 32, and an icon. In other words, the icon composer 33 may be configured to generate an icon that indicates that the BVM image corresponds to the left side of the vehicle, and the BVM image when the BVM image corresponding to the left side of the vehicle is generated by the BVM image generator 32. In addition, the icon composer 33 may be configured to generate an icon that indicates that the BVM image corresponds to the right side of the vehicle, and the BVM image when the BVM image corresponding to the right side of the vehicle is generated by the BVM image generator 32.

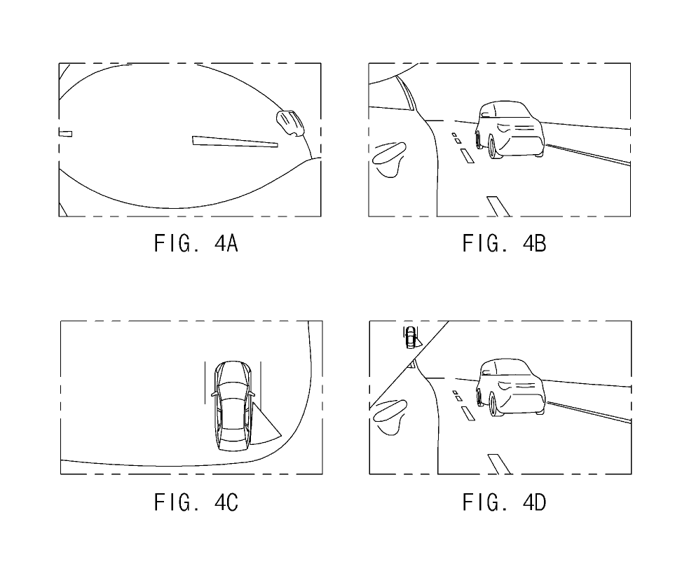

Hereinafter, the operations of the BVM image generator 32 and the icon composer 33 will be described with reference to FIGS. 4A-4D. FIGS. 4A-4D are exemplary views illustrating a process to generate a BVM image, according to an exemplary embodiment of the present disclosure; and illustrate the process to generate a BVM image based on the image obtained through the left view camera 23.

As illustrated in FIG. 4A the right-side image of the vehicle is captured by the right view camera 24. Since each of the front view camera 21, the rear view camera 22, and the left view camera 23 as well as the right view camera 24 is a camera also included in an SVM system, a fisheye lens may be included, and thus an image shown in FIG. 4A may be captured. In addition, since each of the cameras 21 to 24 is a camera applied to the SVM system, the cameras 21 to 24 may be mounted to face a road surface for the purpose of capturing an optimal SVM image, and thus most of the captured images may be occupied by the road surface. FIG. 4B indicates a BVM image generated by the BVM image generator 32 based on FIG. 4A, and FIG. 4C may be an icon image and may indicate that the image in FIG. 4B is the right-side blind spot image of a vehicle.

The icon composer 33 may be configured to generate the images in FIGS. 4B and 4C to generate the image in FIG. 4D. At this time, the icon composer 33 may be configured to generate an icon image (not illustrated) for providing a notification that the BVM image is the left-side blind spot image of the vehicle, when the BVM image is generated based on the image captured by the left view camera 23. For example, the first display 40 may include an audio video navigation (AVN) display positioned in the center fascia of the vehicle, as a device configured to display an SVM image. The center fascia refers to the control panel board positioned between the driver's seat and a front passenger seat in the center of the dashboard.

For example, the second display 50 may include a cluster and a head up display (HUD), as a device configured to display a BVM image. The first display 40 and the second display 50 may include at least one of a liquid crystal display (LCD), a thin film transistor-liquid crystal display (TFT-LCD), an organic light-emitting diode (OLED), a flexible display, a 3D display, and an e-ink display. The first display 40 and the second display 50 may have a mutual layer structure with the touch sensor or may be integrally formed with the touch sensor, and thus may implement a touch screen.

Furthermore, the controller 60 may be configured to execute overall control such that each of the components is capable of normally performing functions of the components. The controller 60 may be implemented in the form of hardware or software, or may be the combination of hardware and software. Favorably, the controller 60 may be implemented as a microprocessor, but is not limited thereto. In particular, the controller 60 may be configured to determine the SVM mode or the BVM mode based on the signal received through the signal input device 10, and then perform the following process. At this time, the controller 60 may be configured to determine that the SVM mode is selected, when the SVM button is pressed by the driver or the gear of the vehicle is in the reverse gear. The controller 60 may be configured to determine that the current mode is the BVM mode, when the turn signal is input.

During the BVM mode, the controller 60 may be configured to activate the left view camera 23 when the left turn signal is input, activate the right view camera 24 when the right turn signal is input, and notify the view converter 30 of the activation result. The controller 60 may further be configured to activate the first display 40, all of the front view camera 21, the rear view camera 22, the left view camera 23, and the right view camera 24, and operate the view converter 30 to generate the SVM image, when operating in the SVM mode.

Additionally, the controller 60 may be configured to activate the second display 50 (at this time, the controller 60 may not perform an operation when the second display 50 is already activated), activate the left view camera 23 when a left turn signal is input, activate the right view camera 24 when a right turn signal is input, operate the view converter 30 to generate a left-side blind spot image of a vehicle (to compose an icon image for providing a notification that the image corresponds to the left side) when the left view camera 23 is activated, and operate the view converter 30 to generate a right-side blind spot image of a vehicle (to compose an icon image for providing a notification that the image corresponds to the right side) when the right view camera 24 is activated, when operating in the BVM mode.

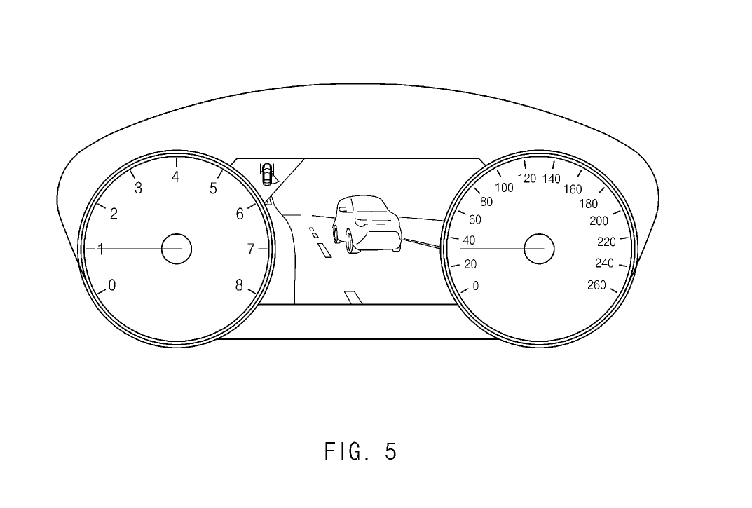

Moreover, as illustrated in FIGS. 4A-D, the controller 60 may be configured to operate the second display 50 to display the BVM image shown in FIG. 4D generated by the view converter 30. For example, the displayed BVM image may be illustrated in FIG. 5. In FIG. 5, the second display 50 may indicate a cluster, and an icon image that indicates whether the BVM image currently displayed on one side of an upper end of the display screen is the left side or the right side of the vehicle may be displayed. In the case of the HUD, the BVM image may be displayed in the same manner.

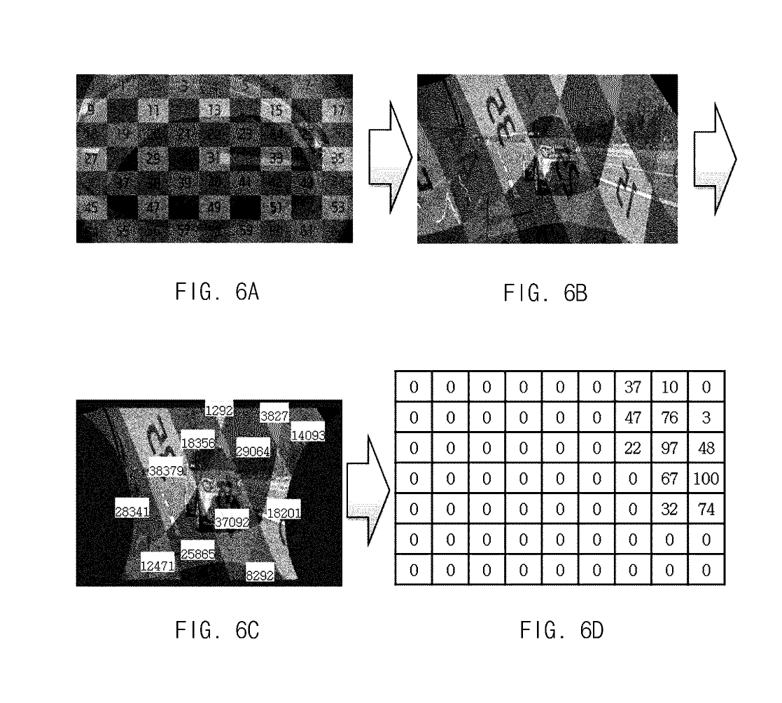

In the meantime, a process in which the controller 60 tunes AE, (i.e., sets AE) when the left view camera 23 and the right view camera 24 operate in the BVM mode will be described with reference to FIGS. 6A-6D. This is to solve the problem that the optimal BVM image fails to be generated when the saturation phenomenon (e.g., the state where the brightness of the specific area in the image exceeds a critical value) occurs due to the headlight of the rear vehicle at the time of the nighttime or tunnel driving.

FIGS. 6A-6D are exemplary views illustrating a process to tune a camera for operating in a BVM mode, according to an exemplary embodiment of the present disclosure. Generally, since the cameras 21 to 24 applied to the SVM system include a fisheye lens and are mounted to face the road surface, most of the captured images are occupied by the road area. The cameras 21 to 24 control (e.g., adjust the brightness of the image) AE based on the whole brightness of the captured image (e.g., the brightness of all the pixels); the cameras 21 to 24 determine that the captured image is dark due to a high proportion of the road area appearing relatively dark in the captured image, and thus control the AE to increase the whole brightness. The captured SVM image is optimal in the SVM system. However, since the saturation phenomenon occurs in the area of the SVM image to be converted to a BVM image when the SVM image is converted to the BVM image, the optimal SVM image may not be generated.

FIGS. 6A-6D illustrate a process for solving the above-described problem. First, for the purpose of detecting the area in the SVM image to be converted to the BVM image, the controller 60 may be configured to equally divide the window (e.g., the sensing area of a CCD sensor or the sensing area of a CMOS sensor) of the image shown in FIG. 4A into areas of the predetermined number, and sequentially assigns identification numbers from ‘0’. The image to which the identification number is assigned is as illustrated in FIG. 6A.

Afterwards, the controller 60 may be configured to convert the image shown in FIG. 4A to the BVM image using the view converter 30. The converted image is as illustrated in FIG. 6B and it is understood that the location and size of the divided area are also changed during the conversion process. The controller 60 may then be configured to count the number of pixels of each area in the image of FIG. 6B. The result is as illustrated in FIG. 6C.

The controller 60 may then be configured to set the weight of the largest area to 100% (maximum) and set the weight of the remaining area depending on the ratio that is based on the size of the largest area. The result is as illustrated in FIG. 6D. For example, the weight is 50%, when the area of the other area is 5, when the area of the largest area is 10 (at this time, the weight is 100%). Afterwards, as illustrated in FIG. 6D, the controller 60 may be configured to set the weight for each area of the window to the right view camera 24. The left view camera 23 may be processed in the same manner.

Further, the right view camera 24 may be configured to adjust the AE based on the brightness (e.g., the brightness of each of the pixels in an area) of an area to which the weight is assigned. The right view camera 24 may be configured to adjust the brightness of the corresponding area by reflecting the weight of each area, and then adjust the AE based on the brightness of each area. For example, the AE may be adjusted in consideration of only the brightness of each of first to third areas, when the brightness of the first area is 10, the weight of the first area is 100%, the brightness of the second area is 10, the weight of the second area is 50%, the brightness of a third area is 10, the weight of the third area is 10%, and the weight is not assigned to each of the fourth area to tenth area. The AE may be adjusted in consideration of the fact that the brightness of the first area is 10, the brightness of the second area is 5, and the brightness of the third area is 1.

For reference, the degree of exposure may be determined by a combination of shutter speed, aperture opening degree, a gain value (e.g., an analog gain value or a digital gain value), and the like. As a result, the left view camera 23 and the right view camera 24 may be set to a first mode (SVM mode) or a second mode (BVM mode) under control of the controller 60. In particular, in the second mode, since an image is captured in a state tuned in the manner described above with reference to FIGS. 6A-6D, saturation phenomenon in the image may be prevented.

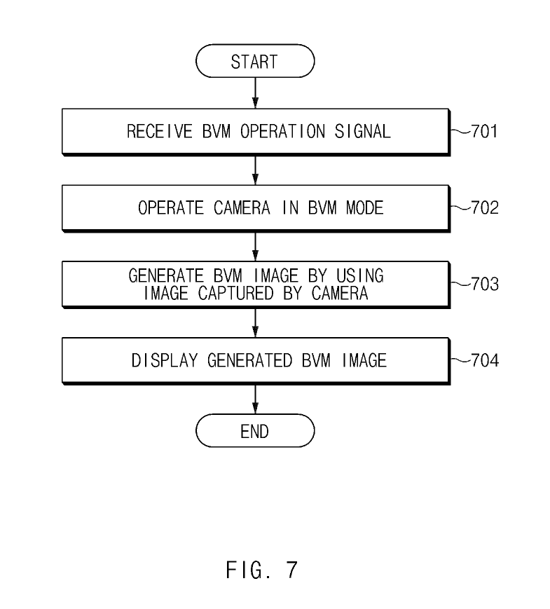

FIG. 7 is a flowchart illustrating an exemplary embodiment of a method of providing a BVM image in an SVM system, according to an exemplary embodiment of the present disclosure.

First, in operation 701, the signal input device 10 may be configured to receive a BVM operation signal. At this time, the signal input device 10 may be configured to receive the SVM operation signal. Afterwards, in operation 702, the controller 60 may be configured to operate the left view camera 23 or the right view camera 24 in a BVM mode. In particular, the controller 60 may be configured to operate the left view camera 23 in the BVM mode when receiving a left turn signal of a vehicle as the BVM operation signal from the signal input device 10 and operate the right view camera 24 in the BVM mode when receiving a right turn signal of the vehicle.

Afterwards, in operation 703, the view converter 30 may be configured to generate a BVM image using the image captured by the left view camera 23 or the right view camera 24. The view converter 30 may be configured to generate the BVM image using the image captured by the left view camera 23 or generate the BVM image using the image captured by the right view camera 24. In operation 704, the second display 50 may be configured to display the generated BVM image. The SVM image may be displayed by the first display 40.

Through the above-described process, the SVM system may provide an optimal BVM image. The present disclosure according to an exemplary embodiment may operate in an SVM mode or a BVM mode based on the driving state of a vehicle, and then may provide an image optimized in each mode.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, exemplary embodiments of the present disclosure are not intended to limit the technical spirit of the present disclosure, but provided only for the illustrative purpose. The scope of protection of the present disclosure should be construed by the attached claims, and all equivalents thereof should be construed as being included within the scope of the present disclosure.

What is claimed is:

1. A surround view monitoring (SVM) system having a function to provide a blind-spot view monitoring (BVM) image, comprising:
a signal input device configured to receive an SVM operation signal or a BVM operation signal;
an image capture device including a front view camera, a rear view camera, a left view camera, and a right view camera;
a view converter configured to generate an SVM image or a BVM image, using an image captured by the image capture device;
a first display configured to display the SVM image;
a second display configured to display the BVM image; and
a controller configured to operate the left view camera or the right view camera in a BVM mode during the BVM mode, operate the view converter to generate the BVM image based on an image captured through the left view camera or the right view camera, and operate the second display to display the BVM image generated by the view converter.

2. The SVM system of claim 1, wherein the left view camera and the right view camera operate in an SVM mode or the BVM mode under control of the controller.

3. The SVM system of claim 2, wherein the left view camera and the right view camera adjust Auto Exposure to prevent saturation in an area of the SVM image to be converted to the BVM image.

4. The SVM system of claim 1, wherein the signal input device includes:
an SVM button configured to generate an SVM mode signal; and
a turn signal input device configured to generate a left turn signal and a right turn signal, as the BVM operation signal.

5. The SVM system of claim 4, wherein the controller is configured to operate the left view camera in the BVM mode when the left turn signal is input, and operate the view converter to generate the BVM image based on the image captured using the left view camera.

6. The SVM system of claim 5, wherein the view converter is configured to generate an icon that indicates that the BVM image is a left-side blind spot image of a vehicle, and the BVM image.

7. The SVM system of claim 4, wherein the controller is configured to operate the right view camera in the BVM mode when the right turn signal is input, and operate the view converter to generate the BVM image based on the image captured using the right view camera.

8. The SVM system of claim 7, wherein the view converter is configured to generate an icon that indicates that the BVM image is a right-side blind spot image of a vehicle, and the BVM image.

9. The SVM system of claim 1, wherein the second display includes a cluster and a head up display (HUD).

10. A blind-spot view monitoring (BVM) image providing method of a surround view monitoring (SVM) system, comprising:
receiving, by a signal input device, a BVM operation signal;
operating, by a controller, a camera in a BVM mode;
generating, by a view converter, a BVM image using an image captured by the camera; and
displaying, by a display, the generated BVM image.

11. The method of claim 10, wherein the camera operates in an SVM mode or the BVM mode under control of the controller.

12. The method of claim 11, further comprising:
adjusting, by the camera, Auto Exposure to prevent saturation in an area of an SVM image to be converted to the BVM image.

13. The method of claim 10, wherein the BVM operation signal is a left turn signal or a right turn signal of a vehicle.

14. The method of claim 13, wherein the operating of the camera in the BVM mode includes:
operating, by the controller, a left view camera in the BVM mode when the left turn signal is input.

15. The method of claim 14, wherein the generating of the BVM image includes:
generating, by the view converter, the BVM image based on an image captured using the left view camera; and
generating, by the view converter, an icon that indicates that the generated BVM image is a left-side blind spot image of the vehicle, and the BVM image.

16. The method of claim 13, wherein the operating of the camera in the BVM mode includes:
operating, by the controller, a right view camera in the BVM mode when the right turn signal is input.

17. The method of claim 16, wherein the generating of the BVM image includes:
generating, by the view converter, the BVM image based on an image captured using the right view camera; and
generating, by the view converter, an icon that indicates that the generated BVM image is a right-side blind spot image of the vehicle, and the BVM image.

18. The method of claim 10, wherein the display includes a cluster and a head up display (HUD).
